(19) United States
(12) Patent Application Publication
(10) Pub. No.: US 2002/0030887 A1
(43) Pub. Date: Mar. 14, 2002

(54) Stereoscopic Display Without Using Eyeglasses

(76) Inventors: Goro Hamagishi, Osaka (JP); Masutaka Inoue, Osaka (JP)

Correspondence Address: Nikaido, Marmelstein, Murray & Oram LLP, Metroplitan Square, 655 Fifteenth Street, N.W., Suite 330-G Street Lobby, Washington, DC, 20005-4810, US

(21) Appl. No.: 09/481,571

(22) Filed: Jan. 11, 2000

(30) Foreign Application Priority Data
Jan. 11, 1999 (JP) 4362/1999

(51) Int. Cl. G02B 27/22

(52) U.S. Cl. 359/463

(57) ABSTRACT

This invention provides a stereoscopic display without using eyeglasses which does not require means for switching images for right and left eyes and by which a viewer can observe a stereoscopic image even when the viewer moves. A stereoscopic display without using eyeglasses of the present invention comprises a projector 1 for projecting an image for a left eye and an image for a right eye in sequence, image forming means 2a for forming images for right and left eyes projected from the projector 1 onto a diffusion plate 2b, shutter means 4 which includes a plurality of shutter regions positioned horizontally which can switch between light transmission and light shading, and forms a narrow-width image light reaching region, of which width is smaller than that of the image forming region, in each image forming region on the diffusion plate 2b, light guide means 2c for converging a image from a narrow-width image light reaching region in the image forming region to a desired position apart from the diffusion plate 2b by spacing a distance half of the interval between the pupils or smaller, and shutter control means 5 which makes a set of more than two shutter regions of the shutter means 4 locating side by side and controls light transmission and light shading of the set of shutter regions on the basis of output results from a sensor 10 for detecting a viewer 3's position.

### BACKGROUND OF THE INVENTION

1. Field of the Invention

This invention relates to a stereoscopic display by which a stereoscopic image can be observed without using special eyeglasses.

2. Description of the Prior Art

A stereoscopic display of double-lenticular type which uses two liquid crystal projectors and a double lenticular screen as a screen has been proposed to display a stereoscopic image without using special eyeglasses. In this stereoscopic display as shown in FIG. 8, one liquid crystal projector 100a displays an image for a left eye, and another liquid crystal projector 100b displays an image for a right eye. The images from the projectors are projected on a double lenticular screen 200 which is arranged in front of the projectors. The double lenticular screen 200 is constituted by lenticular screens 200a and 200c arranged on both front and back sides of a diffusion plate 200b for forming an image so as to sandwich the diffusion plate 200b therebetween. Images for right and left eyes become vertical stripe-shaped images 200bL and 200bR respectively when passing through the lenticular screen 200a, which is positioned on a light incident side (on the side of liquid crystal projectors 100a and 100b). Then the vertical stripe-shaped images 200bL and 200bR are alternately formed on the diffusion plate 200b. After that, these images are separated into the stripe-shaped images for a right eye and the strip-shaped images for a left eye by passing through the lenticular screen 200c which is positioned on a light emitting side of the diffusion plate 200b (on the side of a viewer), then the image for a right eye is guided to a right eye (3R) of a viewer 300 and the image for a left eye is guided to a left eye (3L) of the viewer 300. The viewer, who observes these vertical stripe-shaped images for right and left eyes by the respective eyes, can observe a stereoscopic image without using special eye-glasses, due to the binocular parallax effect.

The stereoscopic display of this type alternately provides regions in which an image for a right eye or an image for a left eye is visible at the optimum viewing distance from a screen 200 (“D” in the figure) as shown in FIG. 9. The “R” region marked by an arrow is a region where an image for a right eye can be observed and the “L” region marked by an arrow is a region where an image for a left eye can be observed. A cross talk region where an image for a right eye and an image for a left eye are simultaneously observed exists between the L region and the R region. The crosstalk region occurs due to aberration of the lenticular screen 200 etc. Accordingly, a viewer can observe a stereoscopic image when the right eye 3R of the viewer is in the “R” region and the left eye 3L is in the “L” region (the viewer is at the “A” position in the figure). On the other hand, when the right eye of the viewer is in the “L” region and the left eye is in the “R” region (the viewer is at the “B” position in the figure), a viewer observes a pseudo-stereoscopic image and cannot observe a stereoscopic image.

The conventional methods which can prevent a pseudo-stereoscopic image caused by a shift of the viewer's head include the following one. As illustrated in FIGS. 10 and 11, a sensor 10 for detecting a head position of a viewer 300 detects a head position of the viewer 300. When the sensor determines the viewer is at a pseudo-stereoscopic viewing position, images from the two projectors 100a and 100b (not shown in FIGS. 10 and 11) are switched from one another to exchange the images for right and left eyes to be displayed. In such a construction, when the viewer 300 moves from the stereoscopic image viewing position to the pseudo-stereoscopic image viewing position (FIG. 10), the images are switched from one another as shown in FIG. 11. As a result, an image viewing region “R” of a diamond shape can be placed at a position corresponding to the viewer's right eye, and an image viewing region “L” of a diamond shape can be placed at a position corresponding to the viewer's left eye.

However, the above method requires means for switching an image for a right eye and an image for a left eye when the viewer moves to a pseudo-stereoscopic region. In addition, when the head of the viewer moves to the left or right by half of the interval between the pupils from a stereoscopic region, the viewer is at a crosstalk region where images for right and left eyes are observed by one eye. As a result, the viewer can not observe a stereoscopic image.

Still, when a screen is a large sized one, many people observe images. In this case, when one viewer moves and images for right and left eyes are switched in response to the viewer's head tracking, other viewers in a stereoscopic region can not observe a stereoscopic image.

U.S. application Ser. No. 09/275,434 has proposed a stereoscopic display in which many viewers can observe a stereoscopic image without using means for switching images for right and left eyes.

### SUMMARY OF THE INVENTION

The present invention has been made to provide a stereoscopic display by which a viewer can observe a stereoscopic image even when the viewer shifts to a pseudo stereoscopic region or a crosstalk region from a stereoscopic region without using means for switching images for right and left eyes, and furthermore, each of many viewers can observe a stereoscopic image when many viewers observe the image.

To solve the problem, a stereoscopic display without using eyeglasses of the present invention comprises a projector for projecting an image for a left eye and an image for a right eye in sequence, image forming means for forming images for right and left eyes projected from the projector onto a diffusion plate, shutter means which includes a plurality of shutter regions arranged horizontally and capable of switching between light transmission and light shading, and forms a narrow-width image light reaching region, of which width is smaller than that of the image forming region, in each image forming region on the diffusion plate, light guide means for converging an image from a narrow-width image light reaching region in the image forming region to a predetermined position apart from the diffusion plate by spacing a width not more than half of the interval between the pupils, and shutter control means which makes a set of more than two shutter regions of the shutter means locating side by side and controls light transmission and light shading of the set of shutter regions on the basis of output results from a sensor for detecting a viewer's position.

Furthermore, a stereoscopic display without using eye-glasses of the present invention comprises a first projector for projecting an image for a left eye, a second projector for projecting an image for a right eye, image forming means for forming images for left and right eyes projected from the projectors onto a diffusing plate, shutter means which includes a plurality of shutter regions arranged horizontally and capable of switching between light transmission and light shading, and forms a narrow-width image light reaching region, of which width is smaller than that of the image forming region, in each image forming region on the diffusing plate, light guide means for converging an image from a narrow-width image light reaching region for a left eye in the image forming region for a left eye and converging an image from a narrow-width image light reaching region for a right eye in the image forming region for a right eye to a predetermined position apart from the diffusion plate by spacing a width not more than half of the interval between the pupils, shutter control means which makes a set of more than two shutter regions of the shutter means locating side by side and controls light transmission and light shading of the set of shutter region on the basis of output results from a sensor for detecting a viewer's position.

In the above construction, each image is fractionized in the narrow-width image forming region which is formed in each image forming region on the diffusion plate due to the shutter means. That is, an image light region of narrow-width (a light emitting point) is formed in the narrow-width image light reaching region. Since the shutter control means controls light transmission and light shading of each shutter region, the fractionized image in each narrow-width image light reaching region is converged by spacing a width not larger than a half of the interval between the pupils at the viewing position. And images in a set of narrow-width image light reaching regions, a set of two or more narrow-width image light reaching regions positioned side by side, move respectively, resulting in realization of accurate head tracking of the viewer. The more images in the narrow-width image light reaching regions formed in each image forming region exist, the more viewers can observe a stereoscopic image.

The shutter means includes four shutter regions, and the shutter control means may control to switch between that a set of two shutter regions on the left side and a set of two shutter regions on the right side are to transmit light alternately and that a set of two shutter regions on both ends and a set of two shutter regions on the center are to transmit light alternately in response to projection timing of each image from the projector on the basis of output from the sensor. By this construction, a viewer can observe a stereoscopic image even when the viewer moves to a crosstalk region.

The shutter means may be arranged in front of a projection lens of the projector and may include two or more shutter regions, which can switch light transmission and light shading and are placed horizontally in width smaller than that of the projection lens.

The shutter means may be arranged at a stop of projection lens of the projector and may include two or more shutter regions, which can switch light transmission and light shading and are placed horizontally in width smaller than the projection lens of the projector. In such a construction, regardless of shutter regions of shutter means, an image light from the projector is projected uniformly and an image is formed in a narrow-width image light reaching region in an image forming region on a diffusion plate in response to a light transmitting region of the shutter means without failure.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an explanatory view illustrating a stereoscopic display without using eyeglasses in accordance with a first embodiment of the present invention;

FIG. 2 is an explanatory view illustrating that a viewer 3 moves from the position illustrated in FIG. 1 by the interval between the viewer's pupils;

FIG. 3 is an explanatory view illustrating that a viewer 3 moves from the position illustrated in FIG. 1 by half of the interval between the viewer's pupils;

FIG. 4 is an explanatory view illustrating a stereoscopic display without using eyeglasses in accordance with a second embodiment of the present invention;

FIG. 5A is an explanatory view illustrating a stereoscopic display without using eyeglasses in accordance with a third embodiment of the present invention;

FIG. 5B is an enlarged view of the “B” portion in FIG. 5A;

FIG. 6A is an explanatory view illustrating that a viewer 3 moves from the position illustrated in FIG. 5A by the interval between the viewer's pupils;

FIG. 6B is an enlarged view of the “B” portion in FIG. 6A;

FIG. 7A is an explanatory view illustrating that a viewer 3 moves from the position illustrated in FIG. 5A by half of the interval between the viewer's pupils;

FIG. 7B is an enlarged view of the “B” portion in FIG. 7A;

FIG. 8 is an explanatory view illustrating a conventional stereoscopic display without using eyeglasses;

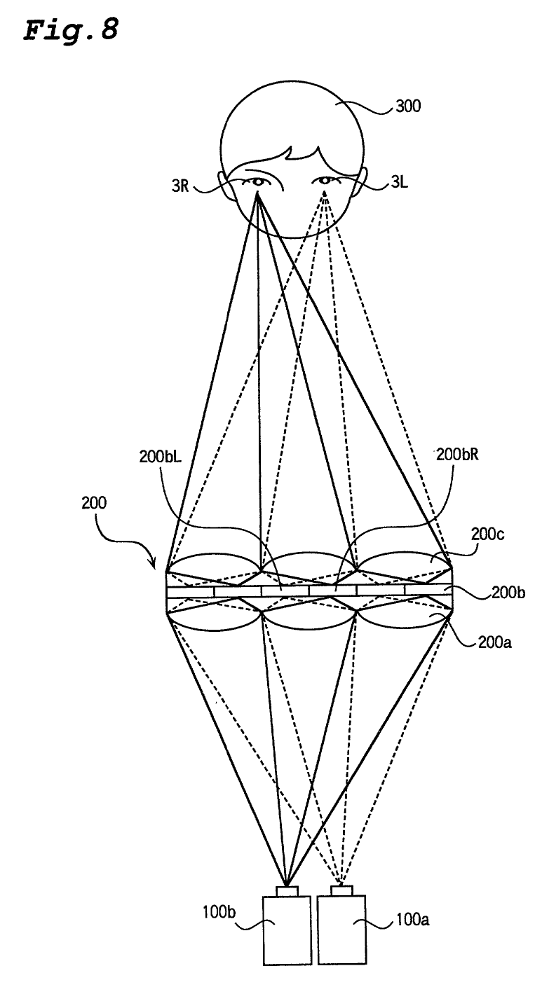

FIG. 9 is an explanatory view illustrating that regions in which images for a right eye and for a left eye can be observed alternately exist in the construction of FIG. 8;

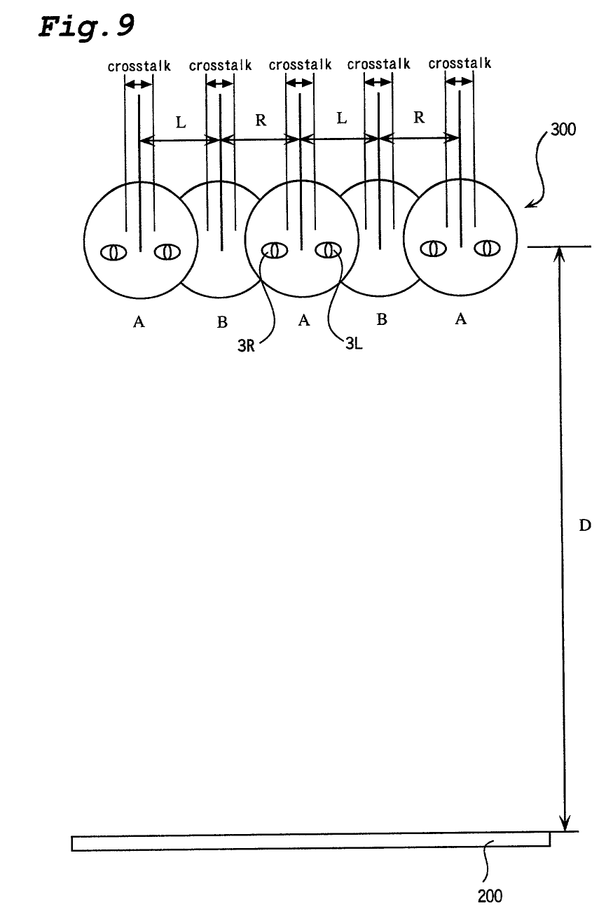

FIG. 10 is an explanatory view illustrating that images displayed for right and left eyes switch alternately in response to a viewer's position in the construction of FIG. 8; and

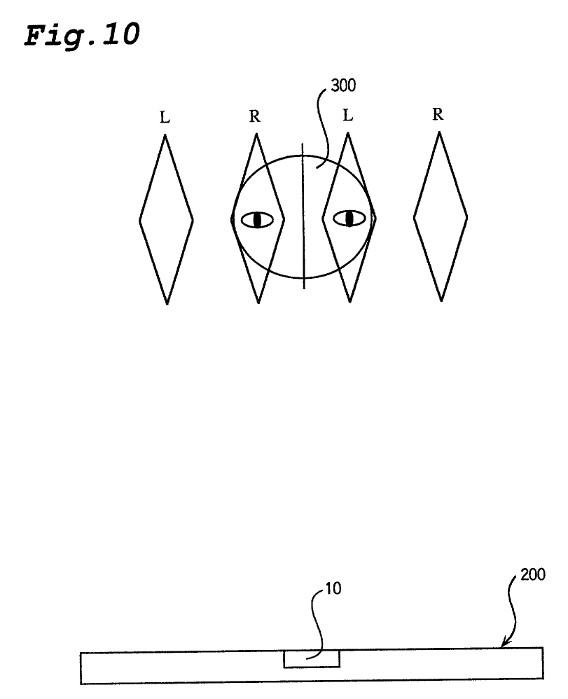

FIG. 11 is an explanatory view illustrating that images displayed for right and left eyes switch alternately in response to a viewer's position in the construction of FIG. 8.

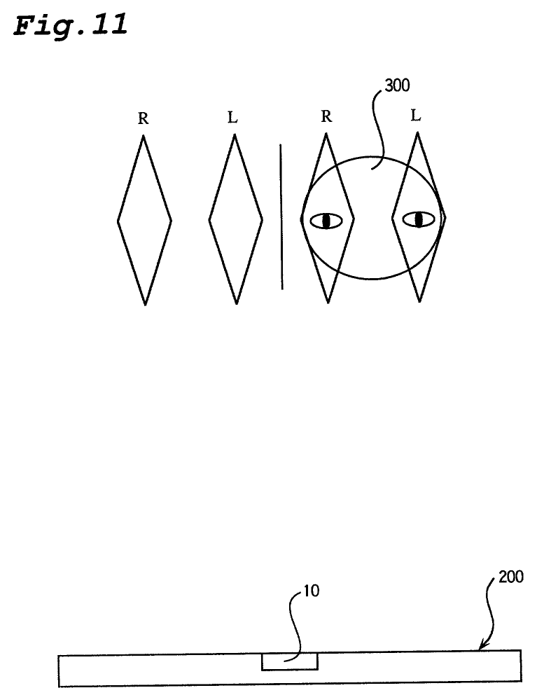

### DETAILED DESCRIPTION OF THE PREFERRED EMBODIMENTS

(The First Embodiment)

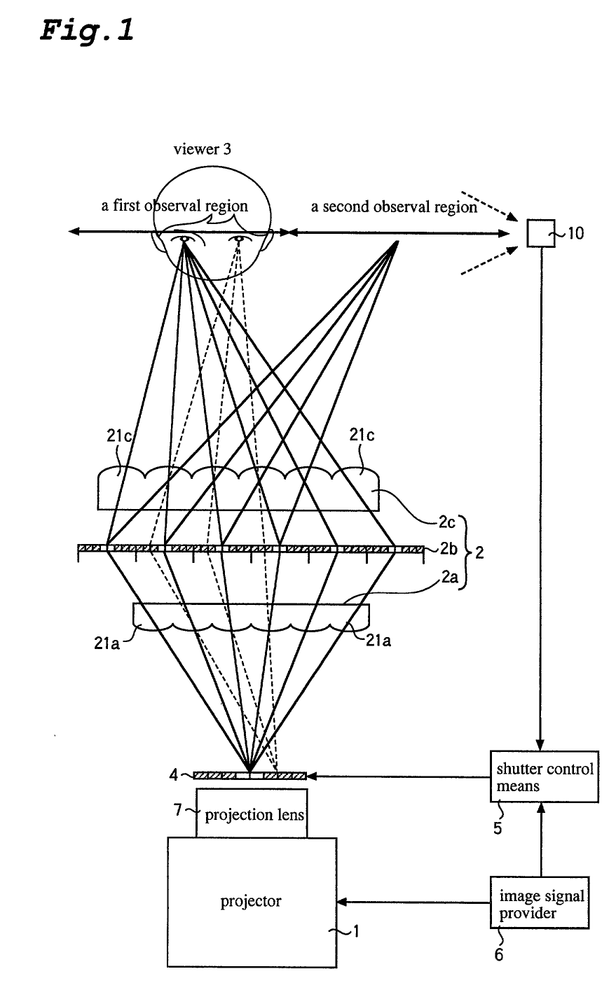

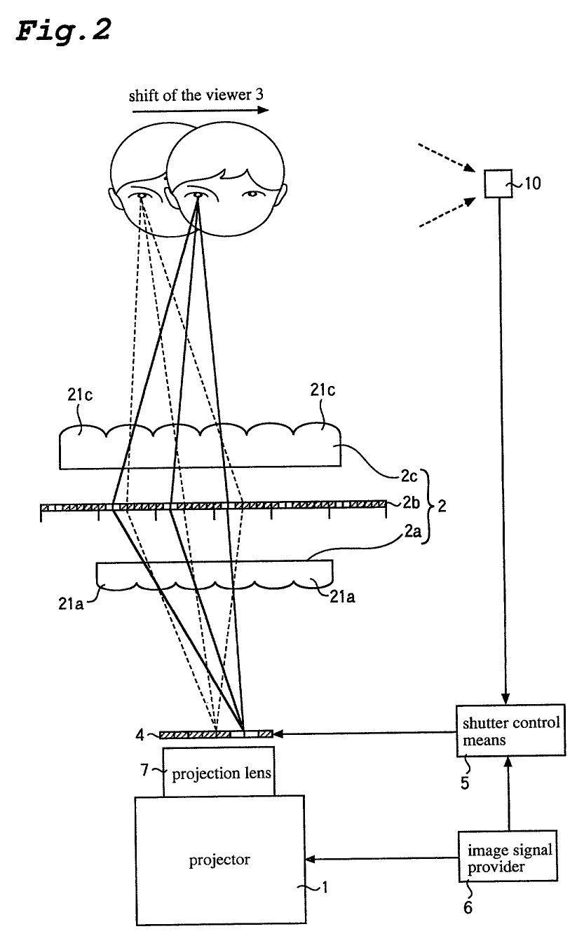

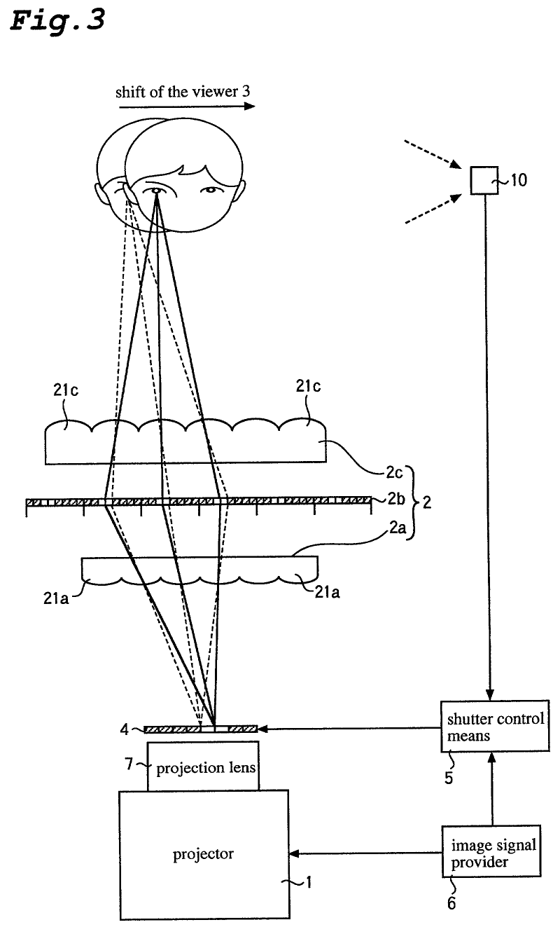

Embodiments of this invention will be described in detail by referring to the drawings. FIG. 1 is an explanatory view illustrating a stereoscopic display without using eyeglasses in accordance with a first embodiment of this invention. FIG. 2 is an explanatory view illustrating that a head of a viewer 3 moves to the left from the position illustrated in FIG. 1 by the interval between the viewer's pupils. FIG. 3 is an explanatory view illustrating that a viewer's head 3B moves to the left from the position illustrated in FIG. 1 by half of the interval between the viewer's pupils.

The stereoscopic display without using eyeglasses in accordance with the first embodiment comprises a screen 2, a projector 1, shutter means 4 which is arranged in front of a projection lens of the projector 1, a sensor 10 for detecting a head position of a viewer 3, shutter control means 5 for controlling the shutter means 4 on the basis of values detected by the sensor 10, and an image signal supplier 6.

The projector 1 projects an image for a left eye and an image for a right eye in sequence on the basis of an image signal transmitted from the image signal supplier 6. One example of the projector 1 is a liquid crystal projector. The image signal supplier 6 processes image signals and supplies them to the projector 1. By this process, the image for a left eye and the image for a right eye are projected in sequence from the projector 1.

The shutter means 4 has eight shutter regions, which are positioned horizontally and can switch between light transmission and light shading, and the width of the region is smaller than that of the projection lens. The shutter means 4 includes a TN liquid crystal layer, a pair of transparent glass plates which sandwich the TN liquid crystal layer, ITO stripe-pattern electrode of one glass plate, ITO electrode of another glass plate, and light polarizing plates on a light emitting side or light polarizing plates on a light emitting side and on a light incident side. The ITO stripe-pattern electrode comprises ITO layer in eight vertical stripes-shape corresponding with the number of the shutter regions. Although a TN liquid crystal panel is used as the shutter means in this embodiment, liquid crystal panels of other types, such as polymer dispersed liquid crystal panel, can also be used.

The shutter control means 5 controls light transmission and light shading of the shutter regions on the basis of output results from the sensor 10 in response to a position of the viewer 3. In FIG. 1, the shutter means 4 is controlled to choose the fourth and fifth shutter regions on the left side of the figure as apertures regions which transmit light in synchronization with projection timing on which an image for a right eye is projected from the projector 1, and to choose the sixth and seventh shutter regions on the left side of the figure as apertures in synchronization with projection timing on which an image for a left eye is projected from the projector 1 in sequence. In FIG. 2 where the head of the viewer 3 illustrated in FIG. 1 shifts to the right by the interval between the pupils, the shutter means 4 is controlled to choose the sixth and seventh shutter regions on the left side of the figure as apertures in synchronization with projection timing on which an image for a right eye is projected from the projector 1, and to choose the first and eighth shutter regions on the left side of the figure as apertures in synchronization with projection timing on which an image for a left eye is projected from the projector 1 in sequence.

The screen 2 comprises a diffusion plate 2b as an image forming surface, a lenticular lens on a light incident side 2a as image forming means arranged on a light incident side of the diffusion plate 2b, and a lenticular lens on a light emitting side 2c as light guide means arranged on a light emitting side of the diffusion plate 2b. The lenticular lens on a light incident side 2a includes lens portions 21a . . . and forms an image for a left or right eye projected from the projector 1, in vertical stripe-shape, onto the diffusion plate 2b. By passing through the shutter means 4 and the lenticular lens on the light incident side 2a, narrow-width images for a left eye or a right eye of which number corresponds with that of the shutter regions chosen as apertures are formed in an image forming region corresponding with the image on the diffusion plate 2b. The lenticular lens on the light emitting side 2c includes lens portions 21c . . . which are arranged by a pitch corresponding with a pitch of each image forming region of the diffusion plate 2b. A narrow-width image for a left eye or a right eye which is formed in the image forming region on the diffusion plate 2b corresponding with the shutter region of light transmitting state is guided to the left eye or the right eye of the viewer 3.

When all shutter regions of the shutter means 4 are chosen as apertures (the whole area becomes transparent), the whole image forming regions serve as a light emitting point. Consequently, an image, which passes through each of the lens portion 21c and is observed at a viewing position, becomes much larger than the interval between the pupils, resulting in that the viewer can not recognize a stereoscopic image. When an image light having a width corresponding with one shutter region of the shutter means 4 passes, the one region of the image forming regions (a narrow-width image forming region) on the diffusion plate 2b serves as a light emitting point. Consequently, an image, which passes through the one region of the image forming regions and each of the lens portion 21c and is observed at a viewing position, is half of the interval between the viewer's pupils, and the image light passes through with the width corresponding to the set of shutter regions, the size of the image viewed at a viewing position is equal to the interval between the pupils.

When the one region of the image forming regions (the narrow-width image forming region) shifts by one, an image, which passes through the lens portion 21c corresponding with this region and is observed at a viewing position, shifts by a length equal to half of the interval between the pupils.

As shown in FIG. 2, the viewer 3 shifts to the left from the position illustrated in FIG. 1 by the interval between the pupils (pseudo-stereoscopic region). A sensor 10 detects the shift of the viewer 3 and gives that information to the shutter control means 5. The shutter control means 5 gives a signal on shutter ON/OFF information to the shutter means 4. The shutter ON/OFF signal in the case of FIG. 2 tells the shutter means 4, when an image for a right eye is projected to the projector 1, to make the fourth and fifth shutter regions as light-shading regions and make the sixth and seventh shutter regions from the left side of the figure as apertures (to make light transmit) and tells the shutter means 4, when an image for a left eye is projected by the projector 1, to make the sixth and seventh shutter regions as light-shading regions and make the first and eighth shutter regions from the left side of the figure as apertures (to make light transmit). When an aperture shutter region shifts at a time of projecting images from the projector 1, the one region of on the diffusion plate 2b (the narrow-width image forming region) shifts to the right by two and an image, which passes through the shifted one region and the lens portion 21c and is observed at a viewing position, shifts to the left by a length equal to the interval between the viewer's pupils, resulting in that the viewer can observe a stereoscopic image even at a position after moving.

As shown in FIG. 3, the viewer 3 shifts to the right from the position illustrated in FIG. 1 by half of the interval between the pupils (a crosstalk region). A sensor 10 detects the shift of the viewer 3 and gives that information to the shutter control means 5. The shutter control means 5 gives a signal on shutter ON/OFF information to the shutter means 4. The shutter ON/OFF signal in the case of FIG. 3 tells the shutter means 4, when an image for a right eye is projected to the projector 1, to make the fourth shutter region as light-shading regions and make the fifth and sixth shutter regions from the left side of the figure as aperture regions (to make light transmit) and tells the shutter means 4, when an image for a left eye is projected by the projector 1, to make the sixth shutter region as light-shading regions and make the seventh and eighth shutter regions from the left side of the figure as aperture regions (to make light transmit). When an aperture shutter region shifts at a time of projecting images from the projector 1, the one region on the diffusion plate 2b (the narrow-width image forming region) shifts to the right by one and an image, which passes through the shifted one region and the lens portion 21c and is observed at a viewing position, shifts to the left by a length equal to half of the interval between the viewer's pupils, resulting in that the viewer can observe a stereoscopic image even at a position after moving.

(The Second Embodiment)

The second embodiment where a single viewer observes an image is described.

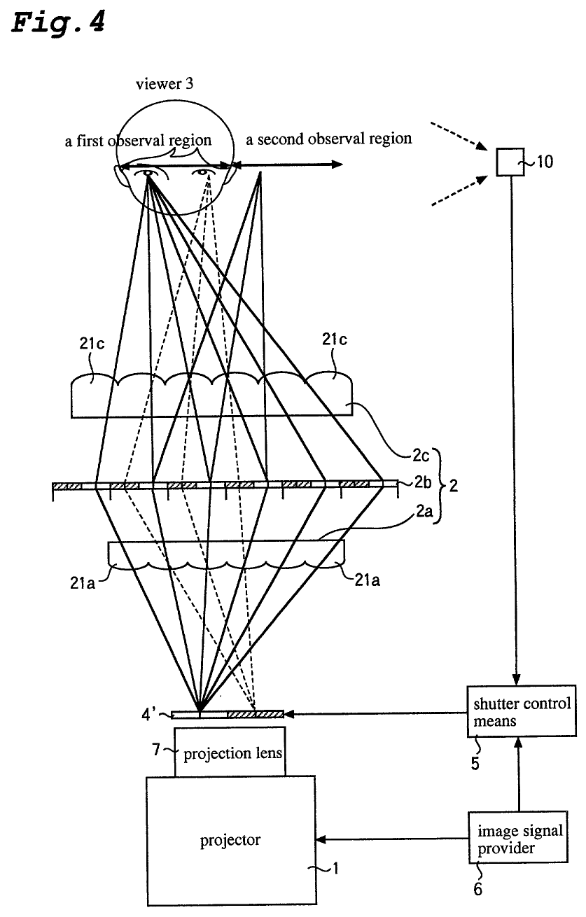

FIG. 4 is an explanatory view illustrating a stereoscopic display without using eyeglasses in accordance with a second embodiment of the present invention. An element having the same function as in the constitution in the first embodiment has the same reference numeral and its explanation is omitted. A difference from the first embodiment is that the number of shutter regions of the shutter means 4′ arranged in front of the projection lens 7 of the projector 1 is four.

In the figure, the shutter means 4′ is controlled to make a set of two shutter regions on the left side as apertures, the first and second regions on the left side of the figure, and set them aperture regions which transmit light in synchronization with projection timing on which an image for a right eye is projected from the projector 1 (see FIG. 4), and is controlled to make a set of two shutter regions on the right side as apertures, the third and fourth regions on the left side of the figure, and set them aperture regions which transmit light in synchronization with projection timing on which an image for a left eye are projected from the projector 1 in sequence. On the contrary, when a head of the viewer 3 shifts to the right by the interval between the pupils from the position illustrated in FIG. 4, the shutter means 4′ is controlled to make a set of two shutter regions on the right side as apertures in synchronization with projection timing on which an image for a right eye are projected from the projector 1 (see FIG. 4), and is controlled to make a set of two shutter regions on the left side as apertures in synchronization with projection timing on which an image for a left eye are projected from the projector 1 in sequence.

When the viewer 3 shifts to the right from the position illustrated in FIG. 1 by half of the interval between the pupils (a crosstalk region), the shutter means 4′ is controlled to make a set of two shutter regions in the center as apertures, the second and third regions on the left side of the figure, when an image for a right eye is projected from the projector 1 (see FIG. 4), and is controlled to make a set of two shutter regions on both of the ends as apertures, the first and fourth regions on the left side, and set the regions in the center as light shading regions when an image for a left eye is projected from the projector 1 in sequence. When an aperture shutter region shifts at a time of projecting images from the projector 1, the one region of the narrow-width image forming region of the diffusion plate 2b shifts to the right by one and an image, which passes through the lens portion 21c from the shifted one region and is observed at a viewing position, shifts to the left by a length equal to half of the interval between the viewer's pupils, resulting in that the viewer can observe a stereoscopic image even when the viewer moves to a pseudo-stereoscopic or a crosstalk region from a stereoscopic region.

In the above first and second embodiments, the single projector 1 projects an image for a left eye and an image for a right eye in sequence. In a third embodiment, the present invention is applied to a stereoscopic display using two projectors.

(The Third Embodiment)

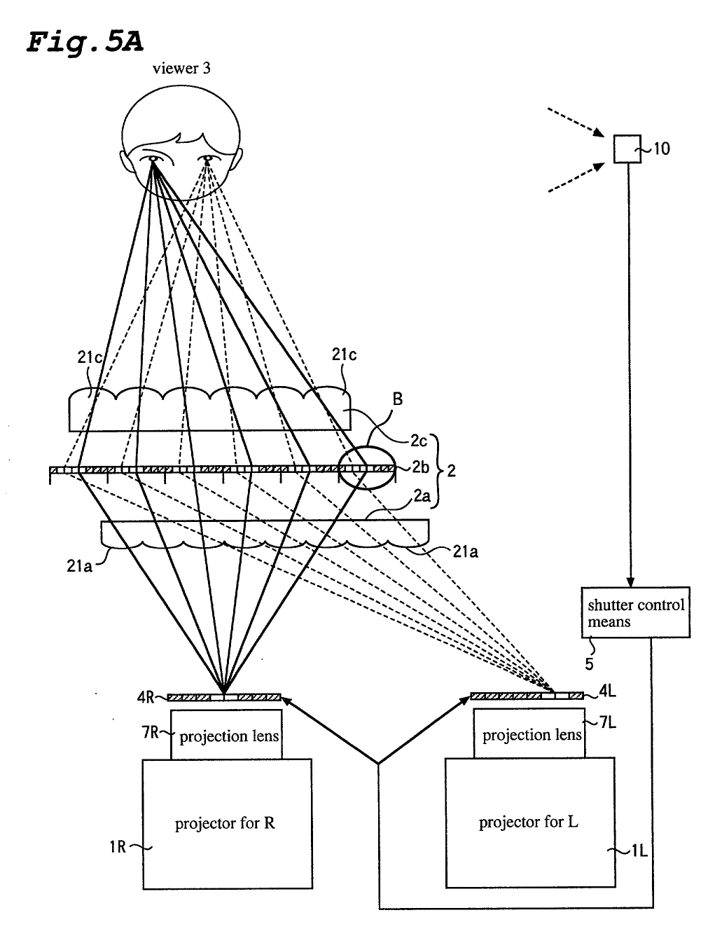

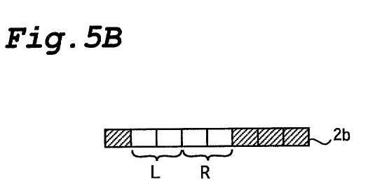

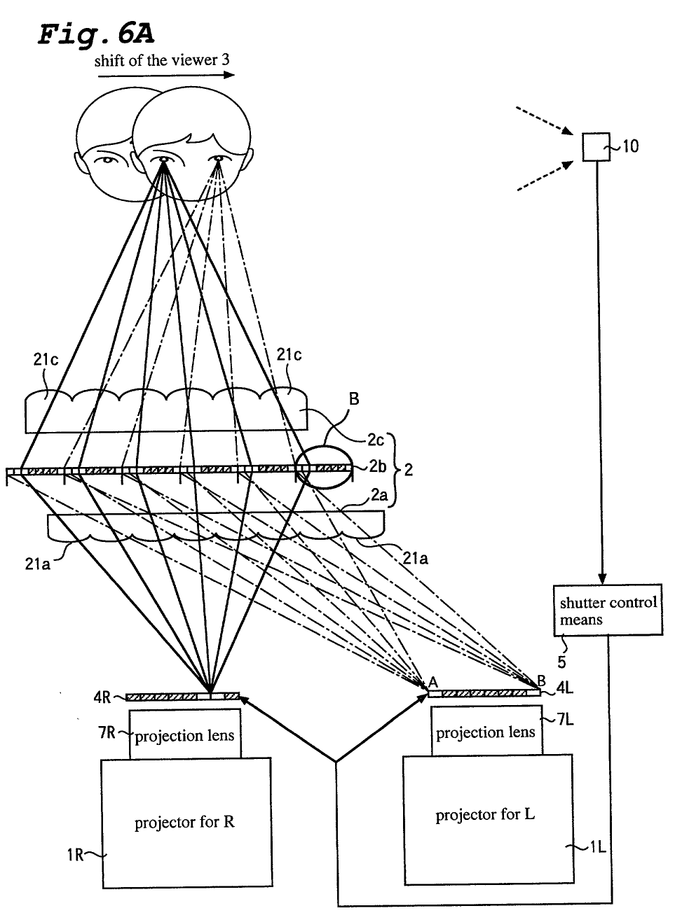

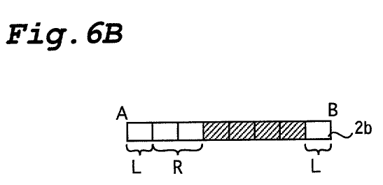

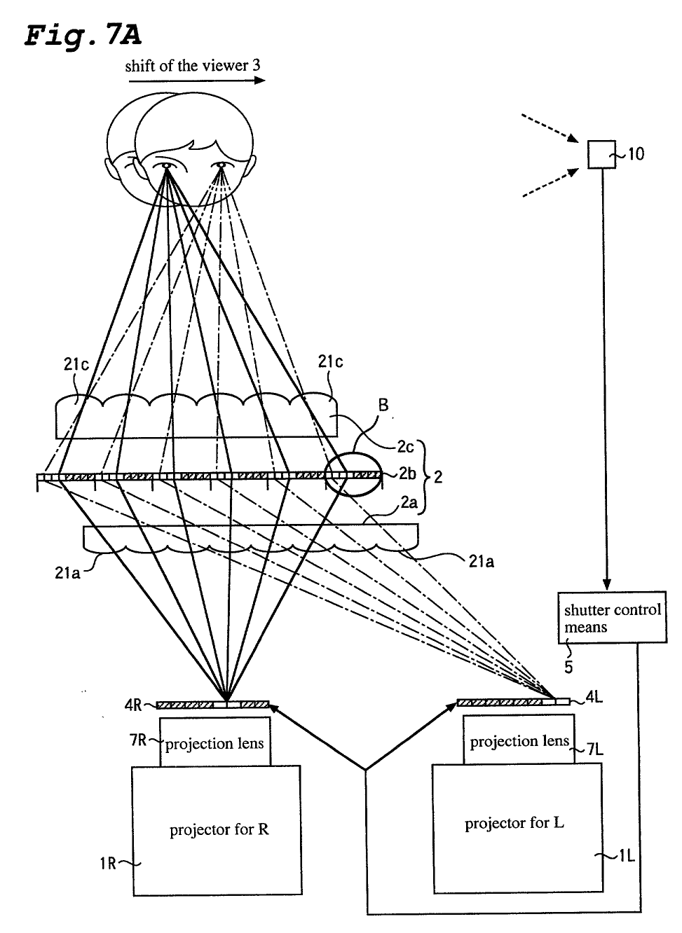

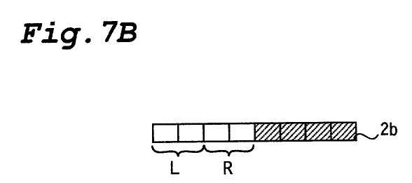

FIG. 5A is an explanatory view showing a stereoscopic display without using eye-glasses according to a third embodiment of this invention. FIG. 6A is an explanatory view illustrating that a viewer's head 3 moves to the left from the position illustrated in FIG. 5A by the interval between the viewer's pupils. FIG. 7A is an explanatory view illustrating that a viewer's head 3 moves to the left from the position illustrated in FIG. 5A by half of the interval between the viewer's pupils. FIG. 5B is an enlarged view of the “B” portion in FIG. 5A, FIG. 6B is an enlarged view of the “B” portion in FIG. 6A, and FIG. 7B is an enlarged view of the “B” portion in FIG. 7A.

The stereoscopic display without using eye-glasses according to the third embodiment comprises a screen 2, a first projector 1L, a second projector 1R, shutter means 4L and 4R which are arranged in front of projection lenses of each projector, a sensor 10 for detecting head positions of viewers 3 . . . , and shutter control means 5 for controlling the shutter means 4L and 4R on the basis of values detected by the sensor 10.

The first projector 1L projects an image for a left eye. The second projector 1R projects an image for a right eye. For example, a liquid crystal projector is used as the projectors 1L and 1R.

The shutter means 4L and 4R have eight shutter regions, arranged horizontally and capable of switching between light transmission and light shading and of which width is smaller than those of the projection lens. Each of the shutter means 4L and 4R includes a TN liquid crystal layer, a pair of transparent glass plates which sandwich the TN liquid crystal layer, ITO stripe-pattern electrode of one glass plate, ITO electrode of another glass plate, and light polarizing plates on a light emitting side or light polarizing plates on a light emitting side and on a light incident side. The ITO stripe-pattern electrode comprises ITO layer in eight vertical stripe-shape corresponding with the number of the shutter regions. Although the shutter means in this embodiment is composed by a TN liquid crystal panel, liquid crystal panels of other types, such as polymer dispersed liquid crystal panel, can also be used.

The shutter control means 5 controls light transmission and light shading of the shutter regions on the basis of output results from the sensor 10 in response to positions of the viewers 3 . . . . For example, the shutter means 4L chooses the sixth and seventh shutter regions from the left side of the figure as apertures, and the shutter means 4R chooses the fourth and fifth shutter regions from the left side of the figure as apertures. In FIG. 6A where the head of the viewer 3 illustrated in FIG. 5A shifts to the left by the interval between the viewer's pupils, the shutter means 4L chooses the first and eighth shutter regions from the left side of the figure as apertures, and the shutter means 4R chooses the sixth and seventh shutter regions from the left side of the figure as apertures.

The screen 2 comprises a diffusing plate 2b as an image forming surface, lenticular lens on a light incident side 2a as an image forming means arranged on a light incident surface of the diffusing plate 2b, and lenticular lens on a light emitting side 2c as a light guide means arranged on a light emitting surface of the diffusing plate 2b. The lenticular lens on a light incident side 2a includes lens portions 21a . . . and forms images for left and right eyes projected from the projectors 1L and 1R in vertical stripe-shape onto the diffusing plate 2b. By passing through the shutter means 4L, 4R and the lenticular lens on the light incident side 2a, narrow-width images for a left eye of which number corresponds with that of the shutter regions chosen as apertures and narrow-width images for a right eye of which number corresponds with that of the shutter regions chosen as apertures are formed on the diffusing plate 2b. The lenticular lens on the light emitting side 2c includes lens portions 21c . . . which are placed by a pitch corresponding with a pitch of each image forming region of the diffusing plate 2b. A narrow-width image for a left eye which is formed on the diffusing plate 2b in response to each shutter region of light transmitting state is guided to the left eyes of the viewer 3, and a narrow-width image for a right eye which is formed on the diffusing plate 2b in response to each shutter region of light transmitting state is guided to the right eyes of the viewer 3.

When all shutter regions of the shutter means 4L and 4R are chosen as apertures (the whole area becomes transparent), the whole area of each image forming region serves as a light emitting point. Consequently, an image, which passes through each lens portion 21c and is observed at a viewing position, becomes much larger than the interval between the viewer's pupils, resulting in that the viewer can not recognize a stereoscopic image. When an image light passes with a width corresponding with one shutter region of the shutter means 4L and 4R, that single region (a narrow-width image forming region) serves as a light emitting point. Consequently, an image, which passes through each lens portion 21c from the single region of each image forming region and is observed at a viewing position, is equal to half of the interval between the viewer's pupils. When an image light passes through with a width corresponding with the set of shutter regions, the image observed at a viewing position is equal to the interval between the pupils in size (see FIG. 5B).

When the single region (the narrow-width image forming region) shifts by a width of a set of shutter regions, an image, which passes through each lens portion 21c and is observed at a viewing position, shifts by a length equal to the interval between the viewer's pupils.

Therefore, when the one region of the image forming regions (the narrow-width image forming region) shifts by one, an image, which passes through the lens portion 21c corresponding with this region and is observed at a viewing position, shifts by a length equal to half of the interval between the pupils.

As show in FIG. 6A, only the viewer 3 shifts to the left from the position illustrated in FIG. 5A by the interval between the viewer's pupils. A sensor 10 detects the shift of the viewer 3 and gives that information to a shutter control means 5. The shutter control means 5 gives signals on shutter ON/OFF information to the shutter means 4R and 4L. The shutter ON/OFF signal in the case of FIG. 6A tells the shutter means 4R to close the fourth and fifth shutter regions and open the sixth and seventh shutter regions (to make light transmit) from the left side of the figure and tells the shutter means 4L to close the sixth and seventh shutter regions and open the first and eighth shutter regions (to make light transmit) from the left side of the figure. By shifting an open shutter region when images are projected from the projectors 1R and 1L, the single region of the diffusing plate 2b (the narrow-width image forming region) shifts to the right by two and an image, which passes through each lens portion 21c from the shifted single region and is observed at a viewing position, shifts to the left by a distance equal to the interval between the viewer's pupils, resulting in that the viewer can observe a stereoscopic image even at a position after moving (see FIG. 6B).

As show in FIG. 7A, only the viewer 3 shifts to the right from the position illustrated in FIG. 5A by half of the interval between the viewer's pupils (a crosstalk position). A sensor 10 detects the shift of the viewer 3 and gives that information to a shutter control means 5. The shutter control means 5 gives signals on shutter ON/OFF information to the shutter means 4. The shutter ON/OFF signal in the case of FIG. 7A tells the shutter means 4R to close the fourth shutter region and open the fifth and sixth shutter regions (to make light transmit) from the left side of the figure and tells the shutter means 4L to close the sixth shutter region and open the seventh and eighth shutter regions (to make light transmit) from the left side of the figure. By shifting an open shutter region when images are projected from the projectors 1R and 1L, the single region of the diffusing plate 2b (the narrow-width image forming region) shifts to the right by one and an image, which passes through each lens portion 21c from the shifted single region and is observed at a viewing position, shifts to the left by a length equal to half of the interval between the viewer's pupils, resulting in that the viewer can observe a stereoscopic image even at a position after moving (see FIG. 7B).

The above third embodiment can be applied to an observation by one viewer as in the second embodiment.

The above-described third embodiment is applicable to a case where a single viewer observes an image as in the second embodiment.

It is to be understood that the invention is not limited in this application to the details of construction and arrangement of parts illustrated in the accompanying drawings, since the invention is capable of other embodiment and of being practiced or carried out in various ways. Also it is to be understood that the phraseology or terminology employed herein is for the purpose of description and not of limitation.

The above embodiments employ lenticular lens as image forming means and light guide means. Instead, parallax barriers can be used although it results in reduction of brightness. Furthermore, multi eye type stereoscopic display without using eyeglasses can be constructed by varying displayed images in response to positions of a viewer (by switching and displaying images which were shoot from various directions).

The shutter means 4, 4′, 4R, and 4L can be arranged at a stop of the projection lenses 7, although they are arranged in front of the projector lens 7 of the projector 1, 1R, and 1L in this embodiment. This arrangement is effective in the following case as described in the above embodiment; the shutter means 4, 4′, 4R, and 4L are arranged in front of the projection lens 7 of the projector 1, 1R, and 1L, the image light does not reach at the narrow-width image light reaching region in each image forming region, which is to be formed in response to transmitting regions of the shutter means 4, 4′, 4R, and 4L at the both ends of the diffusion plate 2b, and fail to form an image due to the arrangement of compositions such as the projector 1, 1R, and 1L, and the diffusion plate 2b etc. When the shutter means 4, 4′, 4R, and 4L are arranged at the stop of the projection lens 7, uniform image light from the projector 1, 1R, and 1L is projected from the projection lens 7 regardless of the shutter regions of the shutter means 4, 4′, 4R, and 4L. As a result, the image is formed in a narrow-width image light reaching region in the image forming region on the diffusion plate 2b in response to the light transmitting region of the shutter means without failure.

Although the above first and third embodiments describe the case where the shutter means 4 have eight shutter regions, other constructions are also possible. The number of the shutter regions can increase, for example, to sixteen in order to control the shutter regions of the shutter means 4 in response to the shifts of head positions of viewers when many viewers observe the image. In such a case, the number of images in the narrow-width image light reaching region which is formed in each image forming region on the diffusion plate 2b increases, thus the stereoscopic image can be observed by more viewers.

As described above, the present invention can provide a stereoscopic display by which a viewer can observe a stereoscopic image even when the viewer shifts to a pseudo stereoscopic region or a crosstalk region from a stereoscopic region without using means for switching images for right and left eyes, and furthermore, each of many viewers can observe a stereoscopic image when many viewers observe the image.

What is claimed is:

1. A stereoscopic display without using eyeglasses comprising,
a projector for projecting an image for a left eye and an image for a right eye in sequence,
image forming means for forming images for right and left eyes projected from said projector onto a diffusion plate,
shutter means which includes a plurality of shutter regions arranged horizontally and capable of switching between light transmission and light shading, and forms a narrow-width image light reaching region, of which width is smaller than that of an image forming region, in each image forming region on said diffusion plate,
light guide means for converging an image from a narrow-width image light reaching region in said image forming region to a predetermined position apart from said diffusion plate by spacing a width not more than half of the interval between the pupils,
shutter control means which makes a set of more than two shutter regions of the shutter means locating side by side and controls light transmission and light shading of said set of shutter regions on the basis of output results from a sensor for detecting a viewer's position.

2. The stereoscopic display without using eyeglasses according to claim 1, wherein
said shutter means is arranged in front of projection lens of said projector and includes two or more shutter regions, which can switch light transmission and light shading and are arranged horizontally in width smaller than that of said projection lens.

3. The stereoscopic display without using eyeglasses according to claim 1, wherein
said shutter means is arranged at a stop of the projection lens of said projector and includes two or more shutter regions, which can switch light transmission and light shading and are arranged horizontally in width smaller than that of said projection lens.

4. The stereoscopic display without using eyeglasses according to claim 1, wherein
said shutter means includes four shutter regions, and
said shutter control means controls to switch between that a set of two shutter regions on the left side and a set of two shutter regions on the right side are to transmit light alternately and that a set of two shutter regions on both ends and a set of two shutter regions on the center are to transmit light alternately in response to projection timing of said each image from said projector on the basis of output from the sensor.

5. The stereoscopic display without using eyeglasses according to claim 4, wherein
said shutter means is arranged in front of projection lens of said projector and includes four shutter regions, which can switch light transmission and light shading and are arranged horizontally in width smaller than that of said projection lens.

6. The stereoscopic display without using eyeglasses according to claim 4, wherein
said shutter means is arranged at a stop of the projection lens of said projector and includes four shutter regions, which can switch light transmission and light shading and are arranged horizontally in width smaller than that of said projection lens.

7. A stereoscopic display without using eyeglasses comprising,
a first projector for projecting an image for a left eye,
a second projector for projecting an image for a right eye,
image forming means for forming images for right and left eyes projected from said projector onto a diffusion plate alternately,
shutter means which includes a plurality of shutter regions arranged horizontally and capable of switching between light transmission and light shading, and forms a narrow-width image light reaching region, of which width is smaller than that of an image forming region, in each image forming region on said diffusion plate,
light guide means for converging an image from a narrow-width image light reaching region in said image forming region to a predetermined position apart from said diffusion plate by spacing a width not more than half of the interval between the pupils,
shutter control means which makes a set of more than two shutter regions of the shutter means locating side by side and controls light transmission and light shading of said set of shutter regions on the basis of output results from a sensor for detecting a viewer's position.

8. The stereoscopic display without using eyeglasses according to claim 7, wherein
said shutter means is arranged in front of projection lens of said projector and includes two or more shutter regions, which can switch light transmission and light shading and are arranged horizontally in width smaller than that of said projection lens.

9. The stereoscopic display without using eyeglasses according to claim 7, wherein
said shutter means is arranged at a stop of the projection lens of said projector and includes two or more shutter regions, which can switch light transmission and light shading and are arranged horizontally in width smaller than that of said projection lens.

10. The stereoscopic display without using eyeglasses according to claim 7, wherein
said shutter means includes four shutter regions, and
said shutter control means controls to switch between that a set of two shutter regions on the left side and a set of two shutter regions on the right side are to transmit light alternately and that a set of two shutter regions on both ends and a set of two shutter regions on the center are to transmit light alternately on the basis of output from the sensor.

11. The stereoscopic display without using eyeglasses according to claim 10, wherein
said shutter means is arranged in front of projection lens of said projector and includes four shutter regions, which can switch light transmission and light shading and are arranged horizontally in width smaller than that of said projection lens.

12. The stereoscopic display without using eyeglasses according to claim 10, wherein
said shutter means is arranged at a stop of the projection lens of said projector and includes four shutter regions, which can switch light transmission and light shading and are arranged horizontally in width smaller than that of said projection lens.
